(19) United States
(12) Patent Application Publication
(10) Pub. No.: US 2009/0230145 A1
(43) Pub. Date: Sep. 17, 2009

(54) Cosmetic Applicator

(76) Inventor: Esteban Fernandez Rodriguez, Zamora (ES)

Correspondence Address: WENDEROTH, LIND & PONACK, L.L.P., 1030 15th Street, N.W.,, Suite 400 East, Washington, DC, 20005-1503, US

(21) Appl. No.: 12/083,218

(22) PCT Filed: Oct. 5, 2006
(86) PCT No.: PCT/ES2006/000555

§ 371 Date: Apr. 7, 2008

(30) Foreign Application Priority Data
Oct. 7, 2005 (ES) U200502197
Apr. 20, 2006 (ES) U200600912

(51) Int. Cl. B67D 5/06; B65D 83/00

(52) U.S. Cl. 222/23; 222/402.1

(57) ABSTRACT

The invention relates to a cosmetic applicator comprising a preferably cylindrical sealed container (6, 10), the top of which is equipped with a non-detachable impervious spray valve (1, 11). The aforementioned container (6, 10) comprises a fill/refill neck (2, 12), a relief valve (3, 14) which ensures that the service pressure is not exceeded and a valve for insufflating compressed air (4, 15). According to the invention, the amount of product to be sprayed that is contained inside the container (6, 10) is always considerably smaller than the internal volume of the container (6, 10), such that the rest of the volume, excluding that occupied by the product is occupied by compressed air which acts as propellant for spraying.

### OBJECT OF THE INVENTION

The present invention, as stated in the descriptive title of this descriptive report refers to an applicator for cosmetics which object is to improve the manner of application of some cosmetic products, such as hair finishing sprays, to obtain better sanitary, ecological and economic results than those obtained with conventional applicators. To this effect the invention provides a refillable applicator that uses compressed air as propellant agent.

### BACKGROUND OF THE INVENTION

Manually pumped atomizers or sprayers with a manually operated external pump that has to be pressed for the atomized liquid to be sprayed are known in the art. These manually pumped sprayers have relative disadvantages that cause the user considerable physical fatigue after prolonged use, such as is the case with those who work in hair and beauty salons and similar. Also, to refill these conventional sprayers requires removing the spray valve together with the corresponding pump, an operation during which soiling and contamination of the elements in contact with the liquid to be sprayed can easily occur.

Also known are conventional aerosols comprising a sealed container and a spray valve and containing a propellant gas. These conventional aerosols have relative disadvantages since they are not refillable and oftentimes use toxic propellants such as butane or propane that may be hazardous to health and may unfavorable impact the composition of the liquid to be sprayed.

### DESCRIPTION OF THE INVENTION

To achieve the objectives of the invention and overcome the disadvantages mentioned in previous sections of this descriptive report, the present invention relates to a cosmetic applicator comprising a sealed container, preferably cylindrical and equipped with a non-detachable, impervious spray valve located in its upper part.

According to the present invention, said recipient comprises, in an innovative manner, a fill/refill neck, a safety valve that ensures the service pressure is not exceeded and an valve for insufflating compressed air; and wherein the amount of product to be sprayed that is contained inside the container is always considerably smaller than the internal volume of the container such that the rest of the volume, excluding that occupied by the product, is occupied by compressed air which acts as propellant for spraying.

According to a first preferred embodiment of the present invention, the aforementioned container includes a level indicator showing the existing amount of product to be sprayed contained inside said container.

According to the preferred embodiments of the present invention, said amount of product to be sprayed has a maximum value that is approximately equal to ⅓ of the internal volume or of the container's height.

According to the first preferred embodiment of the invention said fill/refill neck includes means of gradual depressurization which purpose is to release the compressed air still in the container gently before the container is refilled. Said means may entail a threaded plug equipped with a lateral orifice.

In addition, in said first preferred embodiment of the present invention, the safety valves and the air insufflating valves are located at a point that is approximately mid-height in the container and includes the corresponding and respective internal extensions which length exceeds that required to affix them, said extensions reaching a central area inside the container, in such a manner that even in the event that said container is placed in a horizontal, inverted or in any other position, the product to be sprayed does never occlude the internal ends of said valves.

The aforementioned valve for insufflating may be a non-return valve or a blocking valve to prevent the occurrence of air pressure discharging blows when removing the corresponding insufflator or compressed air hose.

The level indicator previously mentioned may be installed in the lower third of the container. Also, said level indicator may be a translucent or transparent vertical tube joined to the container by racor fittings and with fill level markings. Said level indication may also be provided by the very transparency or translucence of the container itself equipped with fill level markings.

According to the first preferred embodiment of the present invention, said neck, valves and level indicator are arranged on the lateral surface of the applicator's container.

According to a second embodiment of the present invention, the neck through with the liquid to be sprayed is refilled is located on the upper part of the container, and includes a gradual pressure relief valve that allows the compressed air contained within to be gently released before the container is refilled. Said pressure relief valve, the safety valve and air insufflating valve are protected against unexpected impacts by a screen or box fitted with orifices that allow access to said valves.

In addition, in said second embodiment of the present invention, the pressure relief, safety and air insufflating valves are located in the middle area of the lateral surface of the cylindrical container and their internal ends are curved or tilted downwards in order for the respective orifices to be facing the bottom of the container and thus preventing being occluded during the refill operation.

Also, the aforementioned pressure relief, safety and air insufflating valves, could be located preferably in an area different from the middle region on the lateral surface of the container when said container is not cylindrically shaped.

Also, the pressure relief, safety and air insufflating valves could be assembled to the container by means of an internal common conduit that would reach the center of the container and its end would face the bottom of the container.

The aforementioned pressure relief valve could be located in the upper part of the container and an also be used as an alternative or substitute refilling neck.

The cosmetic applicator container could present indentations on its lateral surface to house the valves fitted so the valves would not stick out and would be thus prevented from sustaining direct impacts or hits.

The cosmetic applicator container object of the present invention, and according to the second embodiment, could be opaque and be optionally equipped with a suitable viewing window to view which type of product is inside the container thus preventing the container from being refilled with a product different from that originally contained.

Also according to the second embodiment of the present invention, the particular shape, opening and positioning of the aforementioned refill neck allow for the insertion, before and after the refill operation, of a pipette or tube in such a manner that said pipette or tube can be used as a laboratory pipette to verify the type of product inside the container.

Having the configuration and structure described the cosmetic applicator object of the invention presents economic advantages such as being a reusable device and permitting the use of hair finishing sprays formulations cheaper and of higher quality, since their composition is not affected by the propellant agent. It also possesses ecological and sanitary advantages such as using air instead of other gases that even if were they not harmful to the ozone layer, may be harmful to the user's health when breathed. Another consideration is that the fact that the applicator can be reused also carries an ecological and sanitary advantage.

In terms of the manually pumped sprayers, the cosmetic applicator object of the present invention possesses obvious advantages, since it offers the consumer a more comfortable option than having to repeatedly press the external pump, an action that causes physical fatigue to the professionals that have to use said pumps continuously. Also the spray valve used in the cosmetic applicator object of the invention is a fixed valve, so the user is not required to remove it and therefore the valve is not contaminated with refuse or any other products when it is left to lean against unsuitable surfaces or elements during the refill operation. It must be taken into account that the tubular appendix of the spray pumps is of considerable length and therefore the aforementioned risk of contamination is real and obvious.

Another advantage the cosmetic applicator object of the present invention possesses versus conventional aerosol dispensers, is that because it uses air instead of propellant agents based on toxic gases such as butane or propane, it is not harmful to the health of those professional users—such as hairdressers and similar—that work in atmospheres saturated with said propellant agents they are forced to breath. Also, the compressed air used in the applicator object of the invention does not mix with the ingredients used in the formula of the product to spray, while the gases used in conventional aerosol dispenser liquefy and mix with the ingredients of the hair finishing spray or product to be sprayed, causing the formulations of said hair finishing sprays to be complex and preventing the formulation of more environmentally friendly products.

The next section is a description of the invention accompanied by drawings intended to facilitate the understanding of the information contained in the present descriptive report. Said figures and description are an integral part of this report and are intended for illustration and not for limiting purposes of the scope of the present invention.

### BRIEF DESCRIPTION OF THE FIGURES

FIG. 1. —Represents a schematic profile view showing a lengthwise section of a cosmetic applicator according to a first embodiment of the present invention.

FIG. 2. —Represents a schematic profile view showing a lengthwise section of a cosmetic applicator according to a second embodiment of the present invention.

### DESCRIPTION OF ONE OR SEVERAL EXAMPLES OF THE EMBODIMENTS OF THE INVENTION

This section contains a description of two examples of the present invention referring to the numbering shown in the figures in the previous section.

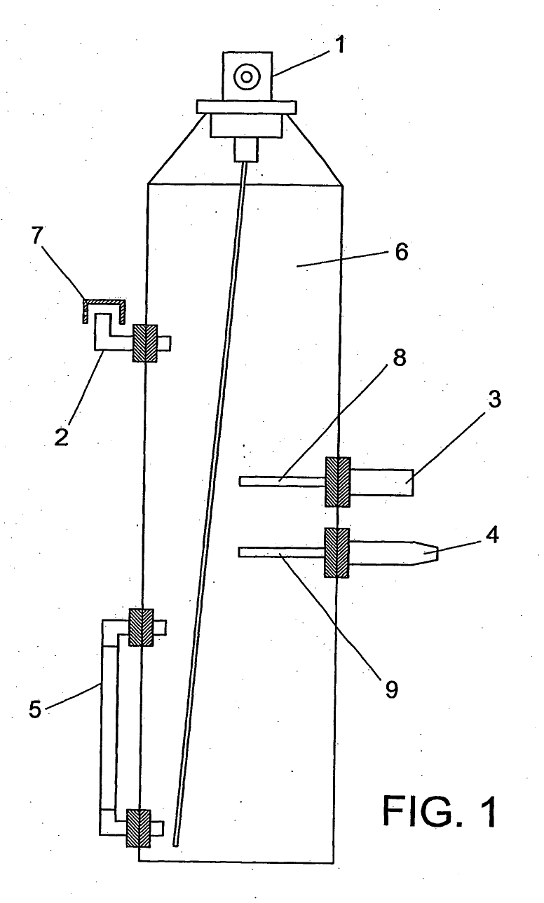

According to said premise, the cosmetic applicator of the first preferred embodiment of the present invention, shown in FIG. 1, comprises a device based on the utilization of compressed air as propellant agent that includes a container 6 shaped as a bottle of cylindrical geometry for ergonomic reasons, as shown in FIG. 1, equipped with various orifices conveniently located that house the components described below.

A spray valve 1 is found in the upper part of container 6. Said valve may be of the aerosol dispensing type or similar. It is affixed securely, firmly and impervious so it can respond to the pressure that will have to be born by the entire device. Affixing methods such as hemming, gluing, welding or sealed thread—so the valve is not handled by the user during normal use of the device—are all suitable methods to secure said valve.

The fill/refill neck 2 is installed in an upper lateral area of container 6 to introduce the liquid product to be sprayed. Threaded plug 7—that includes a lateral orifice intended to gently release the remaining compressed air still inside the container 6 as soon as the unthreading action starts—is very practical to top said fill/refill neck 2. Once said threaded plug has been fully unthreaded, said neck is cleared and can be used to refill container 6, and once refilled the threaded plug 7 is replaced and suitably tightened. The depressible orifice of threaded plug 7 of this fill/refill neck could be substituted by a valve or a different element that fulfils the same function, since the important thing is that said element exists in the device, not its specific shape.

Valve 3 is located closely below neck 2 and also laterally arranged. Valve 3 is suitably calibrated so the service pressure as established by the manufacturer is never exceeded. This valve 3 is not merely screwed or welded onto the container's wall, but its inner side—and this is a significant fact—that is the side inside container 6, has an upper extension 8 required for affixing the valve. Said extension 8 extends approximately to what is the center of the container 6 body and is intended to prevent the liquid product from entering at any times—even when the container is tilted or even placed in a horizontal position—the conduct of safety valve 3, which is only intended to permit the passage of the compressed air, thus preventing possible obstructions. For this same reason, this valve must be located at a midpoint of container 6 and must not be located in the upper part to ensure that valve 3 is equally protected from the liquid to be sprayed in case container 6 was to be completely inverted.

The compressed air insufflation valve 4 must be placed in a similar or slightly lower position to that of safety valve 3—as shown in FIG. 1—. This valve 4 is a non-return valve or blocking valve through which the container is refilled with compressed air without it causing air pressure discharging blows when the air feeding hose is removed. Like safety valve 3 the air insufflating valve 4 is not simply screwed or welded to the wall of container 6, but it is important that its internal part—the part that remains inside the container—has an extension 9 which length is longer than that required to affix the element. Like extension 8, this extension 9 reaches more or less until the mid region of the body of container 6 so the liquid product or hair finishing spray to be dispensed never enters the anti-return valve 4 conduit even if container 6 is tilted and reaches a horizontal position, in such a manner that valve 4 is solely intended as passage for the compressed air. This prevents possible obstruction of said valve 4. In addition insufflating valve 4 is also located in the mid region of the container rather than in the upper part to be protected from the liquid in case container 6 is completely inverted.

Level indicator 5 is installed in the lower third of container 6 so it can indicate the amount of liquid product to be sprayed, since the approximate level to be reached by the maximum amount of liquid to be sprayed is approximately ⅓ of the volume of container 6 cavity, leaving the upper ⅔ of container 6 filled with compressed air. Said level indicator 5 may be a transparent or translucid tube secured by racor fittings to container 6, so they allow viewing product 5 and seeing when the liquid reaches the maximum level as indicated by a level mark in the tube. However, in both examples level indicator 5 may have any other shape provided it serves this function. Installing a level indicator in this device is not a trivial matter, but rather it could be considered as an important innovation of the art, since without the level indicator 5 the container 6 could be excessively filled causing a deficient spraying function due to not having there sufficient space for the compressed air. Another situation could be that the liquid product to be sprayed could enter the conduits or extensions 8 and 9 of valves 3 and 4. If container 6 is made of a transparent or translucid material the maximum liquid level marking may be displayed on the container directly.

Once the device used to illustrate the first example of the present invention has been made with materials suitable to contain the product to be sprayed in compliance with the current applicable legislation, the container 6 can be filled by first introducing the liquid to be sprayed through neck 2 and then introducing the compressed air through valve 4, all of it according to the manufacturer's instructions. Pressing on the depressible button of spray valve 1 for the amount of time desired by the user suffices to operate the device. Said pressing action will cause the product contained within the container to be sprayed in a similar manner as conventional aerosol spray dispensers but with the advantages described in the previous section.

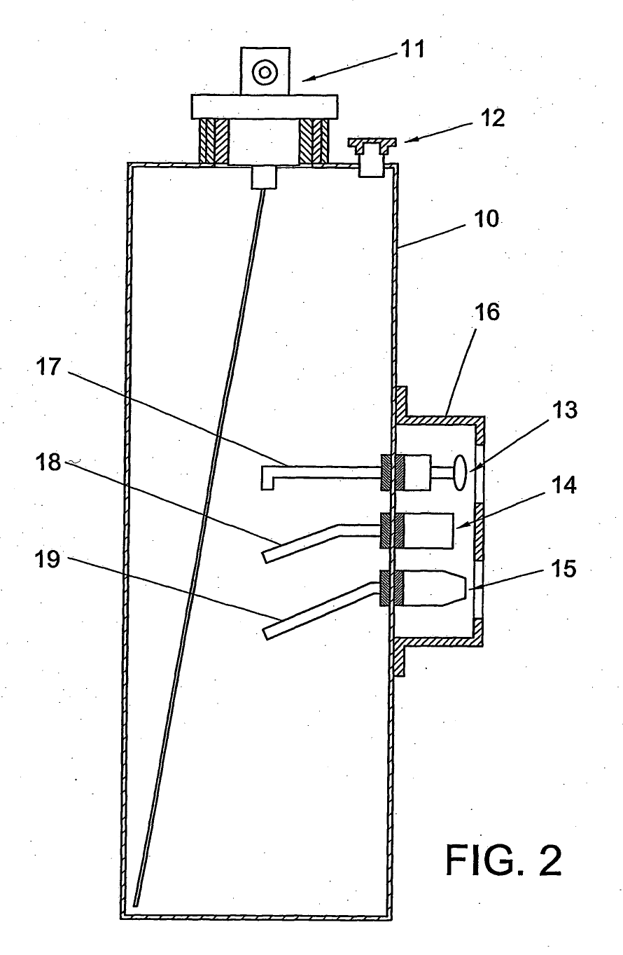

FIG. 2 shows a second embodiment of the invention in which container 10 is a sealed container and is equipped in its upper part with a spray valve 11, and the fill/refill neck 12 in the upper part of container 10 as can be seen in said FIG. 2, instead of in the lateral surface of the container, as is the case in the first embodiment of the invention described before.

Also, this second example of the invention includes a gradual pressure relief valve 13 that allows the compressed air still in the container to be gently released before refilling the container. Pressure relief valve 13, safety valve 14 and air insufflating valve 15 are all protected against unexpected impacts by a screen or box 16 fitted with access orifices as can be seen in FIG. 2.

In this second embodiment the pressure relief valve 13, safety valve 14 and air insufflating valve 15 are located in the mid lateral region of the cylindrical container 10 and their inner ends 17, 18 and 19 respectively have either a curved or downwardly tilted end so the respective orifices face the bottom of container 10 and do not become clogged during the liquid product refill operation, as seen in FIG. 2. This not withstanding, in other embodiments valves 13, 14 and 15 could be preferably located in a region different from the mid lateral surface of the container when said container does not have a cylindrical shape.

Also, in other embodiments of the invention said valves 13, 14 and 15 could have a common internal conduit reaching to the container's center and having its end oriented towards the container's bottom.

Also, in other embodiments of the invention, the pressure relief valve 13 could be located in the upper part of the container and be used as alternative or substitution fill/refill neck. Additionally, in other embodiments of the invention the container could have indentations on its lateral surface to house valves 13, 14 and 15 so they would not stick out and thus prevent them from receiving direct impacts.

According to the second embodiment of the present invention, as shown in FIG. 2, container 10 is opaque, but it could be optionally fitted with a viewing device to view the type of product inside the container to prevent it from being refilled with a different product. Also in this second embodiment of the invention fill/refill neck 12 could have a particular shape, opening and positioning that would allow for the insertion, before and after the refill operation, of a pipette or tube in such a manner that said pipette or tube can be used as a laboratory pipette to verify the type of product inside the container 10.

1-19. (canceled)

20. COSMETIC APPLICATOR comprising a sealed container (6, 10), preferably cylindrical and having in its upper part an unmovable but removable and impervious spray valve (1, 11); characterized in that said container (6, 10) has a fill/refill neck (2, 12), a safety valve (3, 14) with an internal extension (8, 18) which function is to not allow the operation pressure to be exceeded and a compressed air insufflating valve (4, 15) with an internal extension (9, 19); being always the amount of product to be sprayed contained inside the container (6, 10) substantially lower than the internal volume of the container (6, 10), in such a manner that the remaining volume devoid from said product is occupied by compressed air that acts as propellant agent for the spraying operation.

21. COSMETIC APPLICATOR according to claim 20, characterized in that comprises a level indicator (5) that allows viewing the amount of product to be sprayed contained inside the container.

22. COSMETIC APPLICATOR according to claim 21 characterized in that said level indicator (5) is placed in the lower third of the height of the container (6).

23. COSMETIC APPLICATOR according to claim 20, characterized in that said amount of product to be sprayed is approximately equal to ⅓ of the internal volume or height of the container (6, 10).

24. COSMETIC APPLICATOR according to claim 20, characterized in that the length of said internal extensions (8 and 9) exceeds the length required to affix them, and said internal extensions (8 and 9) reach a central area inside the container (6).

25. COSMETIC APPLICATOR according to claim 24, characterized in that said means comprise a threaded plug (7) with a lateral orifice.

26. COSMETIC APPLICATOR according to claim 20, characterized in that said fill/refill neck (2) includes gradual pressure relief means that allow gently releasing the compressed air still in the container before refilling it.

27. COSMETIC APPLICATOR according to claim 20, characterized in that said safety valve (3) with an internal extension and said air insufflating valve (4) with an internal extension are located approximately at the mid height of the container (6).

28. COSMETIC APPLICATOR according to claim 20, characterized in that said air insufflating valve (4) with an internal extension is an anti-return or blocking valve that prevents air pressure discharging blows when the insufflator or hose used to convey the compressed air are removed.

29. COSMETIC APPLICATOR according to claim 28, characterized in that said level indicator (5) consists of a translucent or transparent vertical tube joined to the container (6) by racor fittings and markings to indicate the level of the liquid contained therein.

30. COSMETIC APPLICATOR according to claim 20, characterized in that said level indicator (5) consists of a translucent or transparent vertical tube joined to the container (6) by racor fittings and markings to indicate the level of the liquid contained therein.

31. COSMETIC APPLICATOR according to claim 20, characterized in that said container (6) is totally or partially transparent or translucid.

32. COSMETIC APPLICATOR according to claim 20, characterized in that said fill/refill neck (2), valves (3 and 4) with internal extensions and level indicator (5) are located in the lateral surface of the container (6).

33. COSMETIC APPLICATOR according to claim 20, characterized in that the fill/refill neck (12) for the liquid to be sprayed is located in the upper part of the container (10) and includes a gradual pressure relief valve (13) that allows the compressed air still in the container to be gently released before the refilling operation, and said pressure relief valve (13), safety valve (14) a curved internal extension (18) and air insufflating valve (15) with a curved internal extension (19), are protected against unexpected impacts by a screen or box (16) provided with access orifices; the respective orifices of said curved or downwardly tilted internal extensions being downwardly oriented.

34. COSMETIC APPLICATOR according to claim 33, characterized in that the pressure relief valve (13), safety valve (14) and air insufflating valve (15) are located in the mid region of the lateral surface of the cylindrical container (10).

35. COSMETIC APPLICATOR according to claim 33, characterized in that the pressure relief valve (13), safety valve (14) with a curved internal extension (18) and air insufflating valve (15) with a curved internal extension (19) are preferably located in an area different from the mid region of the lateral surface of the container when said container is not cylindrically shaped.

36. COSMETIC APPLICATOR according to claim 33, characterized in that pressure relief valve (13), safety valve (14) with a curved internal extension (18) and air insufflating valve (15) with a curved internal extension (19) are assembled to the container through a common internal conduit that reaches the center of the container (10) and which end faces the container's bottom.

37. COSMETIC APPLICATOR according to claim 33, characterized in that the pressure relief valve (13) is located in the upper part of the container (10) and is used also as an alternative or substitutive means to refill the container.

38. COSMETIC APPLICATOR according to claim 33, characterized in that the container (10) presents indentations in its lateral surface to house said valves (13, 14, 15) and prevent them from sticking out so they cannot sustain direct impacts.

39. COSMETIC APPLICATOR according to claim 33, characterized in that said container (10) is opaque and may be optionally fitted with a suitable view window to view which type of product is inside the container, to prevent the container from being refilled with a product different from that originally contained.

40. COSMETIC APPLICATOR according to claim 33 characterized in that the particular shape, opening and positioning of fill/refill neck (12) allow for the insertion, before and after the refill operation, of a pipette or tube in such a manner that said pipette or tube can be used as a laboratory pipette to verify the type of product inside the container (10).
